(19) United States
(12) Patent Application Publication
(10) Pub. No.: US 2006/0222827 A1
(43) Pub. Date: Oct. 5, 2006

(54) Camouflage covering

(76) Inventors: Allan Craig Marshall, Hudson, OH (US); William Hemderson, East Sussex (GB); Michael John Cheese, Kent (GB)

Correspondence Address: Omnova Solutions Inc;Chief Intellectual Property Counsel, 175 Ghent Road, Fairlawn, OH, 44333-3300, US

(21) Appl. No.: 10/565,606

(22) PCT Filed: Jul. 26, 2004
(86) PCT No.: PCT/GB04/03226

§ 371 Date: Jun. 6, 2006

(30) Foreign Application Priority Data
Jul. 24, 2003 (GB) 0317363.0

(51) Int. Cl. B44C 1/17

(52) U.S. Cl. 428/195.1

(57) ABSTRACT

A covering for application on surfaces of a structure to camouflage the structure in an environment, the covering comprising a first sheet having spectral characteristics for visible and near-infrared wavelengths that simulate the spectral characteristics of the environment, wherein the first sheet is at least partially covered on a first surface thereof by a first layer of a first ink which is at least partially transparent to near-infrared wavelengths.

This invention relates to camouflage, and in particular to protecting structures, including vehicles, from detection by more than one detection method.

It is often desirable to protect a structure such as a building or a vehicle from detection. Many means of camouflaging objects are known in the fields of surveillance and wildlife observation. These may consist of built-in protection, such as a paint covering, or removable protection, such as a camouflage net, or may be semi-permanent, such as a demountable screen for shielding a structure.

GB 565,238 describes a process and means for coating buildings and other objects for the purpose of camouflage. A paint-like coating is applied to objects which protects the objects from detection in the visible and infra-red portions of the electromagnetic spectrum.

U.S. Pat. No. 5,549,938 describes a removable camouflage comprising flexible magnetic panels having camouflage patterns provided thereon. The panels are designed to magnetically attach to steel surfaces such as the panels of a vehicle. The chance of visual detection of the vehicle is thereby reduced.

U.S. Pat. No. 4,560,595 discloses a sheet form camouflage material designed to have thermal emission characteristics which match closely the known thermal emission characteristics of the natural environment in which the camouflage material is intended to be used. The sheet can protect objects against detection in the thermal infra-red wavelength range, and is also adapted to provide camouflage in the ultra-violet, visible and photographic infra-red wavelengths. The camouflage material may be attached to a supporting web by means of an adhesive or by mechanical means such as clamps or sewing.

Each of these camouflage systems has problems. Built-in camouflages are of limited use since they are only effective against visual detection in areas whose natural colours match closely the colour(s) of the camouflage system. For example, a temporary building, such as a flat-pack structure, painted with a sand-coloured coating would be camouflaged in desert situations, but would stand out against a jungle environment. The structure would need to be repainted if it were desired to use it in a jungle situation.

The removable camouflage panels of U.S. Pat. No. 5,549,938 are also of limited use. While being convenient to apply or remove, they are only designed to protect an object against visual detection. Surveillance equipment or animals with capability to detect UV or IR emissions, for example, would easily detect the presence of an object protected by the panels.

The sheet material of U.S. Pat. No. 4,560,595 cannot easily and quickly be applied to a structure. The sheet must first be attached to a supporting web, and then somehow attached to a structure to be protected. If the structure is, say, a vehicle, then the sheet must be securely attached to the vehicle to prevent it from being released when the vehicle moves.

It is often important that a camouflage covering should be robust against severe weather and should remain in place and undamaged for extended periods of time.

A brief discussion will now be given of sensing methods available for detecting objects, and of protection means available to protect against detection.

Visible wavelengths can be used, both by land-based surveillance systems or individuals, and by satellites, to detect the presence of objects. Obviously, the position of an object in relation to its surroundings will dictate the type of camouflage cover required to protect against visual detection. The earlier examples of desert and jungle situations would require sand-coloured and patterned green coverings respectively. It is often desirable that the colour of a surface should be changed rapidly in order for a camouflage system to adapt to new surroundings.

Similarly, the surface texture of an object can lend the object to being easy or difficult to detect in visible wavelengths. Surface profiling can be used to protect objects against detection by aerial imaging. If a surface of an object is uneven then light will scatter differently from different parts of it, thus breaking up the lines of the object and rendering it difficult to detect. Shadows created by an object can also be minimised by suitable use of uneven surface profiles.

Ultra-violet sensors can detect an object if the object transmits a UV signature substantially different from that of the object's surroundings. UV pigments can be used to give the surface of an object the correct properties such that it cannot easily be observed by UV sensors.

In an analogous manner, infra-red signatures of objects can make them easy to detect. IR pigments can be used to give an object apparently similar IR properties to the surroundings. A suitable pigment for adapting IR characteristics is carbon black dust. This is suitable for adapting near-IR characteristics. Alternatively, or in addition, highly reflective metallic layers, with energy reflection values of around 78% or higher, can be incorporated beneath an optically coloured but IR transmissive polymer film (e.g. polyethylene). These could suitably be metallised polyester, metallised polyvinylfluoride or metallised PTFE. Such layers have a low emissivity, typically 0.2, or even 0.1 or lower (where 1.0 is totally non-emissive and 0.0 is totally reflective), and can be used to control thermal or far-IR characteristics of a surface. Alternatively, metal flakes such as aluminium or brass flakes could be added within or on the surface of a base substrate.

By appropriate balancing of the relative values of transmission, reflection and absorption of a highly reflective layer, a camouflage layer can be made to match the far-IR properties of an environment. A low emissivity layer can be painted or coated with other components in order to match it to an environment in other wavelengths. However, any materials such as pigments or inks that are applied over the low emissivity layer should preferably be fully transmissive to far-IR such that the far-IR characteristics of the layer are not affected.

IR/Thermal imaging can be used to detect objects via the heat which they produce. Metallised particles or metallised fibres (scrim) incorporated into a material, or a metallised film, can be used to reflect heat produced in the object back toward the source so that the external surface of the object cannot be seen to be producing a great deal of heat. An example of a situation in which this effect might be useful is in protecting a stationary or moving vehicle from detection while the engine of the vehicle is producing a large amount of heat.

In addition, or alternatively, phase change materials can be used to absorb heat from hot spots of objects. For instance, a phase change material which operates at a high temperature could be used to smooth out the heat signature of a boiler housing. The function of phase change materials is described in detail in our co-pending application GB 0207642.0.

Radar is also used in surveillance systems to detect objects. To avoid detection by this method, RADAR absorbing materials (RAMS) can be used in camouflage coverings. RAMs are discussed in U.S. Pat. Nos. 5,523,757 and 4,479,994. Suitable materials for RADAR attenuation include carbon (which may suitably be in the form of carbon fibres) and aluminium-coated glass particles. Such particles are particularly suitable for 35 GHz and 94 GHz RADAR bands.

Finally, it is often useful to absorb acoustic signals so that they cannot be detected. Materials such as high density foam, rubber and ceramics can be effective at damping acoustics.

Known camouflage materials used by armed forces present problems for personnel applying or removing them. Current systems are applied and removed from structures and vehicles using toxic substances, and it has been argued that personnel are therefore exposed to a health risk.

Embodiments of the present invention can provide an improved camouflage covering which can quickly, safely and securely be applied to an object to be protected. Embodiments of the present invention can also protect an object against detection in a range of situations.

According to the present invention there is provided a covering for application on surfaces of a structure to camouflage the structure in an environment, the covering comprising a first sheet having spectral characteristics for visible and near-infrared wavelengths that simulate the spectral characteristics of the environment, wherein the first sheet is at least partially covered on a first surface thereof by a first layer of a first ink which is at least partially transparent to near-infrared wavelengths.

Preferably a second surface of the first sheet opposite the first surface is coated with an adhesive.

Suitably, a backing sheet could be removably attached to the adhesive surface such that the backing sheet could be removed to expose the adhesive surface. The covering could then be applied directly onto a surface of an object to be protected. Suitably, the covering could subsequently be removed from the object without damage to the object.

Suitably the covering could have a second sheet which is similar to the first sheet. The second sheet could suitably be adhered to the first sheet, most preferably to a non-adhesive major surface of the first sheet, in such a way that it could be removed from a first sheet, preferably without damage to either sheet. The feature of providing one or more sheets which can be removed from the remaining sheets could conceivably be useful in situations where it is required to alter the visual appearance of a covering while leaving the other camouflage functions of the covering unchanged. For example, a sand-coloured upper sheet could be removed from a covering at a time when the covering is no longer to be used in a desert situation but is instead to be used in an area with large amounts of vegetation. It would be unnecessary to remove the entire covering, which may still be in good condition after extended use. In accordance with the present invention, the upper sheet could simply be peeled off to reveal a lower sheet. The lower sheet may suit the new environment, or a further sheet could be adhered to it to suit the environment.

Suitably, a further ink could be applied over the first ink layer, to partially cover the first layer. The further ink could be transparent or semitransparent to near-infra-red wavelengths. In the present description, near-IR is taken to be around 600 nm to 1500 nm, and is most preferably 680 nm to 1250 nm. Mid-IR is taken to be 3 μm to 5 μm. This band includes emissions typical of hot engines, boilers and other hot equipment.

One or more of the inks could suitably be partially absorptive to far-infra-red wavelengths. Far-IR wavelengths are taken to be around 8 μm to 14 μm, and most preferably to be 8 μm to 14 μm. Humans and other animals typically emit heat in this range, and so substances capable of absorbing these wavelengths can help to camouflage humans and animals.

The first and/or second sheets could be of a polymer material such as PVC, PVF, polypropylene, polyethylene, silicones, polysulphones or polyesters.

Suitably, the covering could comprise pigments that reflect or absorb ultra-violet and/or infra-red. It could suitably comprise metallised scrim, and the scrim threads could be metallised with aluminium, nickel, chrome or copper.

The covering could suitably comprise one or more radio absorbing material such as carbonyl iron, Kevlar, ferrites, or carbon loaded foams. Suitable classes of RAMs include Salisbury screens, Jaumann absorbers, circuit analogue absorbers, magnetic RAM and Hybrid RAM systems. The covering could suitably comprise a flexible soft-magnetic thin film. This film would act as both RADAR absorber and Infrared reflector. Suitable examples of magnetic films include alloys of cobalt/iron/silicon/molybdenum/boron and cobalt/zirconium/niobium. One component of the covering could suitably comprise a phase change material, such as hydrated aluminium chloride, hydrated magnesium chloride, or Glauber's salt.

The covering could suitably comprise an acoustic absorber. The absorber could be of a substance such as high density foam, rubber or a ceramic system.

The sheet could preferably be flexible such that it could be rolled up for easy transportation, storage, application and manipulation.

Optionally, a layer of lacquer could be applied to the sheet once the ink has been applied. This could provide additional characteristics such as reduced optical surface reflection or resistance to penetration by particular chemical agents. The sheet can then optionally be embossed in order to produce an uneven surface profile which can make the camouflage covering less easy to detect by radar. The sheet could also be embossed prior to being printed. Embossing can provide low surface reflectivity, thus making a covering less easily detectable against a background.

Further preferred features of the invention are set out in the appended claims.

The invention will now be described in detail with reference to the accompanying drawings.

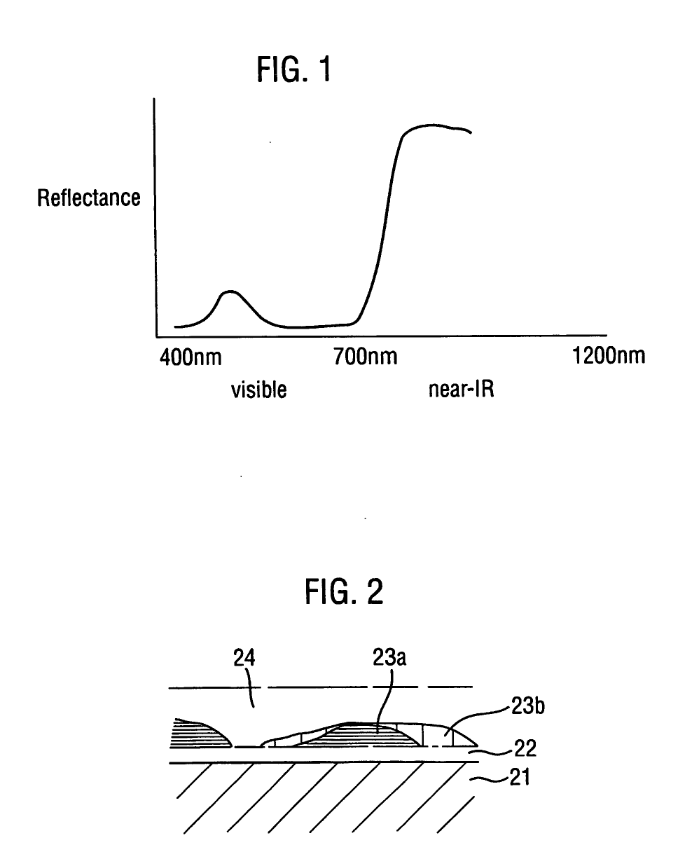

FIG. 1 shows the reflectance spectrum for chlorophyll;

FIG. 2 shows a camouflage covering according to an embodiment of the present invention;

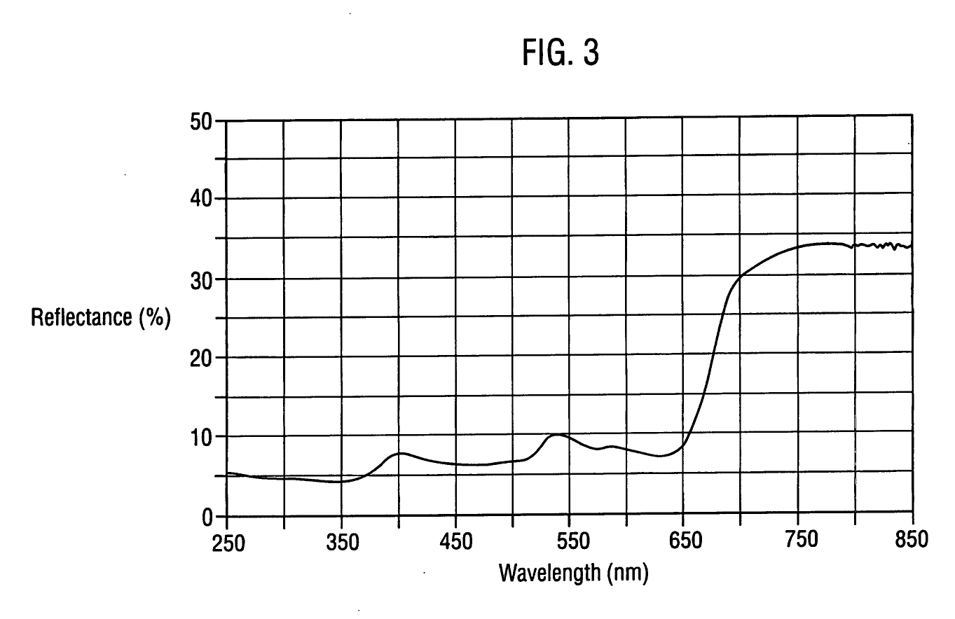

FIG. 3 shows the reflectance characteristics of a covering simulating chlorophyll;

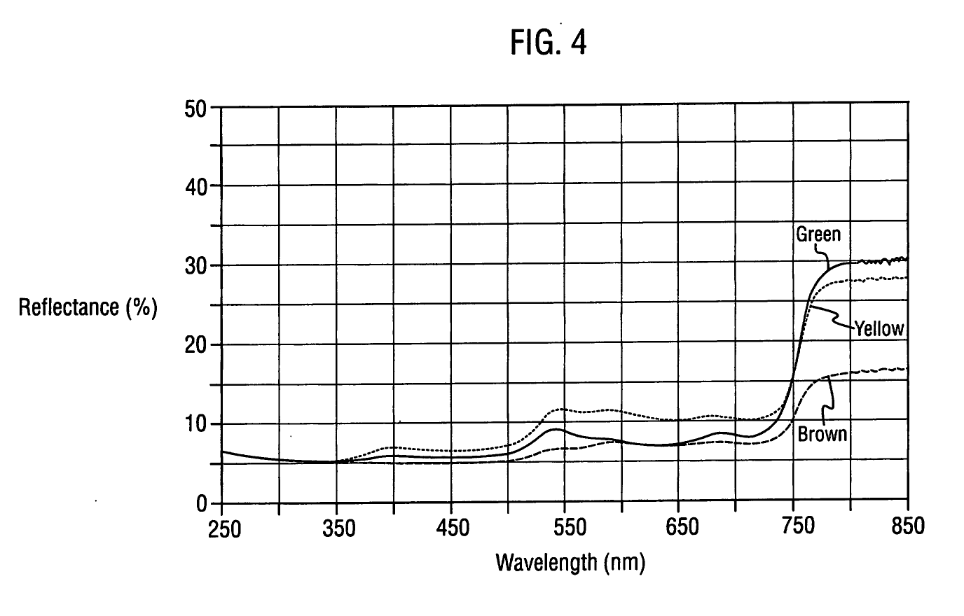

FIG. 4 shows the reflectance characteristics of inks used in embodiments of the invention.

FIG. 1 shows a reflectance spectrum for chlorophyll in the visible and near-infra-red region. Since camouflage equipment is often required in jungle situations or environments with high levels of vegetation, it is highly desirable to produce camouflage equipment which can simulate vegetation. If a camouflage covering is produced which has spectral characteristics that mimic the chlorophyll curve shown in FIG. 1, then the covering can be very difficult to detect at visible or near-infra-red wavelengths.

It can be seen from FIG. 1 that there is a sharp upturn in the reflectance spectrum of chlorophyll at around 700 nanometers. It is therefore desirable to produce a substance which has a low reflectance in the visible region (apart from a relatively small peak at around 500 nanometers) and a much higher reflectance above about 700 nanometers. The peak at around 500 nanometers (green light) can be fairly easily simulated using standard pigments or inks.

In one embodiment, a carrier mixture of acrylic resin and vinyl chloride or vinyl acetate co-polymer is dissolved in a blend of ketone solvents (MIBK/MEK) (methyl iso-butyl ketone/methyl ethyl ketone) and is made UV stable by the addition of a UV absorber component. Alternatively, a water-based carrier could be used. A range of organic and/or inorganic pigments may be added to the base carrier to achieve a wide and selective range of different visual colours and opacities.

Where a polymeric base material is used, it is preferably in calendered film format and can be engineered to exhibit specific colour and near infra red spectral properties by the addition of a selected mixture of organic and inorganic pigments which give both the desired visual characteristics and near-IR reflection characteristics which match chlorophyll's spectral characteristics. Such a combination of pigments can be incorporated so as to create a coloured material matched to the colour and the IR characteristics of chlorophyll. A colour having the spectral characteristics of chlorophyll in visible wavelengths is so-called “NATO green”. This is a visual colour defined by British Standard BS381C:1996. Inks or base films can be produced in any colour. Carbon could also be added to the base film to give radar absorbing properties. In one example, a white base film could be produced having near-IR characteristics matching those of chlorophyll. If desired, such a base film can then be printed with other colours, for example to simulate vegetation.

Suitable additives for adjusting the near-IR radiation (NIRR) characteristics of a film include carbon and titanium dioxide. Pigments of these materials absorb NIRR. A surface of the base film can then be printed over to achieve desired colour effects. For example, a digital printing method can be used, whereby colour pigments contained in a solvent are non-contact-printed onto a surface of the film in order to create a digitally-defined pattern. Typically, microscopic dots of three primary colours, cyan, magenta and yellow, and additionally black, are laid down colour-by-colour. The solvent is then evaporated to leave the colour pigments on the surface of the film, and the human eye integrates the coloured dots to give the desired pattern.

In practice, it tends not to be possible to achieve a white base film, since the carbon pigments impart a grey colour to the film, although the addition of titanium dioxide pigments can counteract this greying effect. It can therefore be desirable to modify the pattern of colour to be printed onto the film to compensate for the colour of the base film. Similarly, if colour pigments are used within the base film, the colours to be printed can be adjusted accordingly to give a desired pattern.

The NIRR reflectivity of a covering could suitably be matched to the NIRR spectrum of the surroundings in which the covering is to be applied. For example, it could be desirable to match it to desert surroundings, or to autumnal foliage. In this way, the covering can be made substantially invisible to night-vision devices which operate in the NIRR portion of the electromagnetic spectrum. Where the NIRR characteristics of the underlying base film match the desired NIRR pattern, NIRR-transparent inks could be used, and these could suitably be non-pigment or dye-based inks. Where it is desirable to modify the NIRR characteristics of the underlying film, the solvent-based pigment inks described above could suitably be used, as these tend to be absorptive to NIRR. The colours of the inks can also be selected to match the visible characteristics of the covering to its surroundings. Selected inks could be applied across the entire surface of a base film, or alternatively they could be applied only to certain areas of the film where it is desired to modify the NIRR or colour characteristics of the base film.

A camouflage covering suitable for concealing structures and objects in jungle-type environments can be constructed according to an embodiment of the present invention as follows. Referring to FIG. 2, a base material 21 comprises pigments exhibiting the characteristics of chlorophyll. In a preferred embodiment, the colour of this material is NATO green. The base material should be relatively strong and hardwearing and could suitably comprise a polymer such as PVC or extruded thermoplastic polyolefin (TPO). Optionally, the base material 21 could be attached, for example using an adhesive, to a fabric layer (scrim) to provide increased strength and durability. A camouflage covering consisting solely of base 21 would produce a uniform reflectance spectrum across its surface. However, jungle-type scenes are unlikely to be uniform, but will rather have a mottled effect, for example as produced by leaves on trees. This mottled effect, or variegated effect, is created by spots or blotches of different colours, and may exist in near-IR as well as in visible wavelengths. It is desirable to simulate this effect so that structures can be better camouflaged. In embodiments of the present invention this may be achieved by incorporating a mix of organic and inorganic pigments within the base 21 and/or by printing over the NATO green layer 21 with a series of inks 23 having varying spectral characteristics. The inks 23 are preferably of colours such as yellow, brown, green and black such that a combination of these colours would be difficult to detect among vegetation. The inks 23 may be transparent, semi-transparent or opaque to near-IR wavelengths. Preferably some of the inks will be visually opaque. As a result of this, when a combination of the inks is applied in a pattern over the NATO green base layer 21, a differential (mottled) effect will be produced which is effective in both visible and near-IR wavelengths.

Suitable inks for use in accordance with the present invention include the following phthalocyanine inks produced by AKZO Nobel Inks: Phthalocyanine Blue and Cu-Phthalocyanine Green. Ink pigments can be added into these carriers to produce desired colours. In this way, a wide range of colours may be produced.

A wash layer 22 can optionally be applied across the NATO green layer 21. This wash layer of a specific ink formulation can be applied to the base material to adjust the overall reflectivity of the camouflage covering. This could be a 100% near-IR transmissive ink which has a specific visual colour reflection. This would then alter the perceived visual colour but retain the near-IR red reflection characteristics of the original base layer.

Above the inks 23, or wash layer 22, a lacquer layer 24 can optionally be applied. This can further control the spectral characteristics of the camouflage covering.

Embossing can also be used to create a mottled effect. The effect of embossing is to vary the depths of the various layers 22, 23, and 24 such that an uneven surface profile is obtained and the NATO green base layer 21 will be suppressed less in areas where the overlying layers have been removed or reduced. Preferably the embossed surface profile will also serve to reduce the apparent surface reflection characteristics.

Optionally, a further layer comprising a protective material may be applied over the layers shown in FIG. 2. This material could be chosen to protect the camouflage covering from nuclear, biological and chemical (NBC) attacks. Polyvinyl fluoride (PVF) such as Tedlar®, is particularly suitable for such an application. It is transparent and can be applied as a film in order to provide a lower surface energy to improve the resistance of the inks and other components of the covering to certain known NBC agents and caustic-based detergent-like chemicals used in typical NBC decontamination procedures. The film of NBC-resistant material may optionally be embossed as described above.

On the opposite surface of the base material to the colour-printed surface, an aluminium ink could be applied. Such an ink provides IR reflectiveness. The ink could be printed onto the base material using a gravure contact print technique, in either a single-pass or a multi-pass operation. Using a multi-pass technique provides for a more even distribution of the ink on the surface and a higher level of cover. Speeds of up to 50 metres per minute can be achieved using gravure printing.

A suitable ink could comprise aluminium flake pigments suspended in an acrylic resin and solvent mix consisting of ketones such as MEK or MIBK. The relative proportions of these substances could suitably be 20% aluminium flake, 10% acrylic resin and 70% ketone solvents. Once printed onto a surface, the solvent base of the ink is evaporated off using non-contact hot air ovens. A scrim reinforcement layer could suitably be applied to the aluminium-coated rear surface of the covering.

While the embodiment described above relates to jungle environments, the present invention can also be applied to other types of environment such as deserts, moorland or stone-based environments. The base pigmented material 21 could be modified to match the spectral characteristics of the environment in which the covering is to be used.

FIG. 3 is a graph showing the reflectance characteristics of a NATO green base layer 21 in accordance with a preferred embodiment of the invention. FIG. 4 shows the reflectance characteristics of three ink mixtures 23 that can be used in accordance with embodiments of the present invention. It can be seen, for example, that the inks shown as green and yellow in FIG. 4 are roughly 30% reflective to near-IR wavelengths, while the brown ink is only about 15% reflective in near-IR.

In further embodiments of the invention, the inks can be modified, or further inks can be used to provide for far-IR absorption. Additionally, radar absorbing materials can be added to the covering, and phase change materials can be used to modify the temperature of the covering relative to the temperature of the object to be concealed.

The camouflage layer described above can suitably be attached to light-weight nets for application on a structure or vehicle. Sheets of printed layers as described could be joined edge-to-edge upon a base net in order to provide a large area of camouflage covering.

Alternatively, a “3-dimensional” sheet covering can be produced from the camouflage layers of embodiments of the present invention. By incising a series of slits or holes, preferably “s”-shaped slits, in a sheet the sheet can be made extensible and can be extended to form a net structure which is much more flexible than an unincised sheet. When such a net is draped over a structure or vehicle to be camouflaged it can offer improved protection compared with a conventional 2-dimensional sheet due to the uneven surface profile it creates.

A further alternative is to use embodiments of the invention for flexible-walled structures such as tents, so that the coverings comprise the walls of the structures by being draped or attached over supporting frames.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1-21. (canceled)

22. A covering that can be applied to a structure to camouflage said structure in an environment, said covering comprising a first sheet of a white material comprising first and second opposite surfaces,
said first surface being at least partially covered by a plurality of inks that act to modify the visible and infrared wavelength reflectance characteristics of said covering so as to simulate those of said environment; and
said second surface optionally being coated with an adhesive.

23. The covering of claim 1 wherein at least one of said plurality of inks is at least partially absorptive to near-infrared wavelengths.

24. The covering of claim 1 wherein at least one of said plurality of inks is at least partially absorptive to far-infrared wavelengths.

25. The covering of claim 1 wherein at least one of said plurality of inks is at least partially reflective to far-infrared wavelengths.

26. The covering of claim 1 wherein at least one of said plurality of inks is at least partially transmissive to far-infrared wavelengths.

27. The covering of claim 1 further comprising a component capable of absorbing radar wavelengths.

28. The covering of claim 27 wherein said absorbing component comprises carbon.

29. The covering of claim 27 wherein said first sheet comprises said component.

30. The covering of claim 1 further comprising a phase change material.

31. The covering of claim 1 wherein the visible and infrared wavelength reflectance characteristics of said covering simulate the visible and infrared wavelength reflectance characteristics of chlorophyll.

32. The covering of claim 1 wherein the near-infrared reflectance characteristics of said first sheet simulate those of chlorophyll.

33. The covering of claim 1 wherein said covering is embossed.

34. The covering of claim 1 further comprising a layer of lacquer.

35. The covering of claim 1 further comprising a highly surface reflective component.

36. The covering of claim 35 wherein said reflective component has a reflectance of at least 78%.

37. The covering of claim 1 further comprising a layer comprising polyvinyl fluoride.

38. The covering of claim 1 further comprising a second sheet removably adhered to said first sheet, at least one surface of said second sheet being least partially printed by one or more inks.

39. The covering of claim 38 wherein said one or more inks modify the visible and infrared wavelength reflectance characteristics of said second sheet so as to permit said second sheet to simulate the visible and infrared wavelength reflectance characteristics of an environment different from that which is simulated by said first sheet when said first sheet is removed from said second sheet.

40. The covering of claim 1 wherein the plurality of inks have differing visible and near-infrared reflectance characteristics.

41. The covering of claim 1 wherein said first surface of said first sheet is completely covered by said plurality of inks.
